(19) United States
(12) Patent Application Publication
(10) Pub. No.: US 2026/0146394 A1
(43) Pub. Date: May 28, 2026

(54) ROAD MILLING CUTTER, ROAD PLANING MACHINE AND ROAD MILLING METHOD

(71) Applicant: Xiaojian CHEN, WA (AU)

(72) Inventor: Xiaojian CHEN, WA (AU)

(21) Appl. No.: 19/027,331

(22) Filed: Jan. 17, 2025

(30) Foreign Application Priority Data
Nov. 26, 2024 (CN) 2024116981114

(51) Int. Cl. E01C 23/088; B02C 18/18; E01C 23/12

(52) U.S. Cl. CPC E01C 23/088; B02C 18/18; E01C 23/127

(57) ABSTRACT

A road milling cutter includes a support body in a cylindrical shape, which includes a first bottom surface, a side surface and a second bottom surface connected sequentially in that order from left to right, multiple first cutting teeth are fixedly disposed on the side surface and are arranged around a central axis of the support body, and the multiple first cutting teeth are inclined towards a rotation direction of the support body; and the support body is configured to rotate around the central axis of the support body to drive the multiple first cutting teeth for cutting rocks on a road surface, which solves a problem of crushing and planing the rocks protruding on the road surface.

### CROSS-REFERENCE TO RELATED APPLICATION

This application claims priority to Chinese Patent Application No. 202411698111.4, filed Nov. 26, 2024, which is herein incorporated by reference in its entirety.

### TECHNICAL FIELD

The disclosure relates to the field of road construction technologies, and more particularly to a road milling cutter, a road planing machine and a road milling method.

### BACKGROUND

There are often protruding rocks on a road surface of mining pits, as well as on a road surface of some construction sites. When vehicles drive on the road surface with protruding rocks, the degree of bumpiness is high, which can easily lead to fatigue damage of the vehicles, result in slow driving speeds, and low work efficiency, and to some extent, it can also cause physical harm to drivers.

Therefore, there is an urgent need for a device and a road milling method that can crushing and flatten the protruding rocks on the road surface.

### SUMMARY

In view of problems existing in the related art, the disclosure aims to solve the problems at least to some extent. Therefore, the disclosure provides a road milling cutter, a road planing machine, and a road milling method, which solve the problems of crushing and flattening protruding rocks on a road surface.

In order to achieve the above purposes, the main technical solutions adopted by the disclosure are as follows.

In a first aspect, the disclosure provides the road milling cutter, which includes a support body in a cylindrical shape, the support body includes a first bottom surface, a side surface and a second surface connected sequentially in that order form left to right, multiple first cutting teeth are fixedly disposed on the side surface and are arranged around a central axis of the support body, and the multiple first cutting teeth are inclined towards a r rotation direction of the support body; and the support body is configured to rotate around the central axis of the support body to drive the multiple first cutting teeth for cutting rocks on a road surface.

In an embodiment, the multiple first cutting teeth are arranged in multiple rows to define rows of first cutting teeth, the first cutting teeth in each row of the rows of first cutting teeth extends along the central axis of the support body and are spaced at an equal interval, and a spacing between each adjacent two rows of the rows of first cutting teeth is equal.

In an embodiment, a diameter of the support body is in a range of 30 centimeters (cm) to 100 cm, and a length of the support body is in a range of 100 cm to 400 cm.

In a second aspect, the disclosure provides the road planing machine, which includes a vehicle body and the road milling cutter as described above. The road milling cutter is disposed on the vehicle body and configured to be in contact with the road surface to cut the rocks.

In an embodiment, a length of the support body is in a range of 100 cm to 400 cm, and a first installation portion is provided on a middle part of the support body in a length direction of the support body; the vehicle body is provided with a first support member, and the first support member is rotatably connected to the first installation portion; a transmission mechanism is installed in the first support member, a power input end of the transmission mechanism is mechanically coupled to a power source installed on the vehicle body, and a power output end of the transmission mechanism is mechanically coupled the first installation portion; or
a length of the support body is in a range of 200 cm to 400 cm, and two ends of the support body in the length direction of the support body are provided with a second installation portion and a third installation portion respectively; the vehicle body is provided with a second support member and a third support member, the second support member is rotatably connected to the second installation portion, and the third support member is rotatably connected to the third installation portion; and a transmission mechanism is installed in the second support member, a power input end of the transmission mechanism is mechanically coupled to a power source installed on the vehicle body, and a power output end of the transmission mechanism is mechanically coupled to the second installation portion; or,
a length of the support body is in a range of 200 cm to 400 cm, a first installation portion is provided on a middle part of the support body in the length direction of the support body, and two ends of the support body in the length direction of the support body are provided with a second installation portion and a third installation portion respectively; the vehicle body is provided with a first support member, a second support member and a third support member, the first support member is rotatably connected to the first installation portion, the second support member is rotatably connected to the second installation portion, and the third support member is rotatably connected to the third installation portion; and a transmission mechanism is installed in the first support member or the second support member, a power input end of the transmission mechanism is mechanically coupled to a power source installed on the vehicle body, and a power output end of the transmission mechanism is mechanically coupled to the first installation portion or the second installation portion.

In an embodiment, the road planing machine further includes a driving device. A length of the support body is in a range of 200 cm to 400 cm, and two ends of the support body in a length direction of the support body are provided with a second installation portion and a third installation portion respectively; the vehicle body is provided with a support member, and a lower part of the support member is provided with a first support part and a second support part arranged at an interval; and the road milling cutter is disposed between the first support part and the second support part, the second installation portion is rotatably connected to the first support part, and the third installation portion is rotatably connected to the second support part; and the driving device is installed on the first support part and located on a side of the first support part facing away from the road milling cutter, and the driving device is mechanically coupled to the road milling cutter.

In a third aspect, the disclosure provides the road milling method implemented by the road milling cutter as described above to cut the rocks protruding on the road surface, and the road milling method includes the following steps:
S1, identifying, according to an image of a working area of the road surface, the rocks in the working area to obtain a position distribution of the rocks in the working area;
S2, determining, according to the position distribution of the rocks in the working area and a rock cutting related area for each of the rocks, individual rocks to be cut and rock clusters to be cut, where the rock cutting related area for each of the rocks is preset. There is no rock in the rock cutting related area of each of the individual rocks to be cut, there is at least one rock in the rock cutting related area of each rock in the rock clusters to be cut, and the at least one rock belongs to the rock clusters to be cut;
S3, identifying, according to an image of each of the individual rocks to be cut, lithology data of each of the individual rocks to be cut; inputting the lithology data of each of the individual rocks to be cut into a cutting parameter generation model to obtain cutting parameters of each of the individual rocks, and cutting each of the individual rocks to be cut by the road milling cutter according to the cutting parameters of each of the individual rocks; during a cutting process of each the individual rocks to be cut, optimizing and adjusting the cutting parameters of each of the individual rocks according to a torque, a vibration frequency and a temperature of the road milling cutter; and
S4, identifying, according to an image of each of the rock clusters to be cut, lithology data of each rock in each of the rock clusters to be cut; inputting the lithology data of a target rock in each of the rock clusters into the cutting parameter generation model to obtain target cutting parameters, and cutting each of the rock clusters to be cut starting from the target rock by the road milling cutter according to the target cutting parameters; during a cutting process of each of the rock clusters, optimizing and adjusting the target cutting parameters, according to the lithology data of a current rock being cut of each of the rock clusters, the torque, the vibration frequency and the temperature of the road milling cutter, and the target rock is a first rock to be cut of each of the rock clusters.

In an embodiment, the identifying, according to an image of a working area, the rocks in the working area to obtain a position distribution of the rocks in the working area, includes:
inputting the image of the working area into a rock detection model, to identify the rocks in the working area and determine positions of the rocks in the working area, and obtain the position distribution of the rocks in the working area, where the rock detection model is a faster region-based convolutional neural network (Faster R-CNN) model with adaptive weight parameters obtained through a pre-training process.

In an embodiment, the rock cutting related area is defined as a rock cutting impact area minus a rock cutting area; and the rock cutting area is a region where a circumcircle of a rock is located, the rock cutting impact area is circular and has a same center with the rock cutting area, and a radius of the rock cutting impact area is equal to a radius of the rock cutting area plus n times a diameter of the road milling cutter, and n is in a range of 1 to 1.5.

In an embodiment, the identifying, according to an image of each of the individual rocks to be cut, lithology data of each of the individual rocks to be cut, includes: inputting the image of each of the individual rocks to be cut into a rock lithology recognition model, to identify the lithology data of each of the individual rocks to be cut;
the identifying, according to an image of each of the rock clusters to be cut, lithology data of each rock in each of the rock clusters to be cut, includes: dividing the image of each of the rock clusters to be cut to obtain an image of each rock in each of the rock clusters to be cut, inputting the image of each rock in each of the rock clusters to be cut into the rock lithology recognition model, to identify lithology data of each rock in each of the rock clusters to be cut; and
the rock lithology recognition model is a convolutional neural network (CNN) model with adaptive weight parameters obtained through the pre-training process, and the CNN model has a you-only-look-once-Version 8 (yolov8) network architecture.

Beneficial effects of the disclosure are as follows.
1. The disclosure provides the road milling cutter. The support body is configured to rotate around the central axis of the support body to drive the multiple first cutting teeth for cutting the rocks, resulting in a high rock crushing efficiency. Further, after cutting the protruding rocks, crushed rocks are easily dispersed, and a smoother road surface is formed, which is beneficial to vehicle driving.
2. The disclosure provides the road milling method, which makes the road milling cutter can efficiently and stably cut rocks with different sizes, thicknesses and lithologies, achieving a purpose of efficiently and safely planing hard ground surfaces.

### BRIEF DESCRIPTION OF DRAWINGS

The disclosure is described by means of the following drawings.

FIG. 1 illustrates a schematic structural diagram of a road milling cutter according to a first embodiment of the disclosure.

FIG. 2 illustrates a schematic structural diagram of a road milling cutter according to a second embodiment of the disclosure.

FIG. 3 illustrates a schematic structural diagram of a road planing machine according to a fourth embodiment of the disclosure.

FIG. 4 illustrates a schematic structural diagram of a road planing machine according to a seventh embodiment of the disclosure.

FIG. 5 illustrates a schematic diagram of a connection structure between the road milling cutter and a support member according to the seventh embodiment of the disclosure.

FIG. 6 illustrates a schematic diagram of a connection structure between two support members and two installation portions according to a fifth embodiment of the disclosure.

FIG. 7 illustrates a schematic diagram of a connection structure between three support members and three installation portions according to a sixth embodiment of the disclosure.

FIG. 8 illustrates a schematic diagram of a connection between a transmission and corresponding components according to a fourth embodiment of the disclosure.

FIG. 9 illustrates a schematic diagram of a connection between a transmission and corresponding components according to a fifth embodiment of the disclosure.

FIG. 10 illustrates a schematic diagram of a connection between a transmission and corresponding components according to a sixth embodiment of the disclosure.

Description of reference numerals: 11, support body; 12, first cutting tooth; 13, first bottom surface; 14, second bottom surface; 111, side surface; 112, first installation portion; 113, second installation portion; 114, third installation portion; 2, vehicle body; 21, first support member; 22, second support member; 23, third support member; 3, installation board; 4, cover board; 5, spring; 6, driving device; 7, support member; 71, first support part; 72, second support part; 8, counterweight device; 9, transmission mechanism; 91, power input end; 92, power output end; and 10, power source.

### DETAILED DESCRIPTION OF EMBODIMENTS

It should be noted that the directions referred to as “up” and “down” in the text correspond to the gravitational directions, and the directions referred as “left” and “right” are horizontal directions perpendicular to the gravitational directions.

### First Embodiment

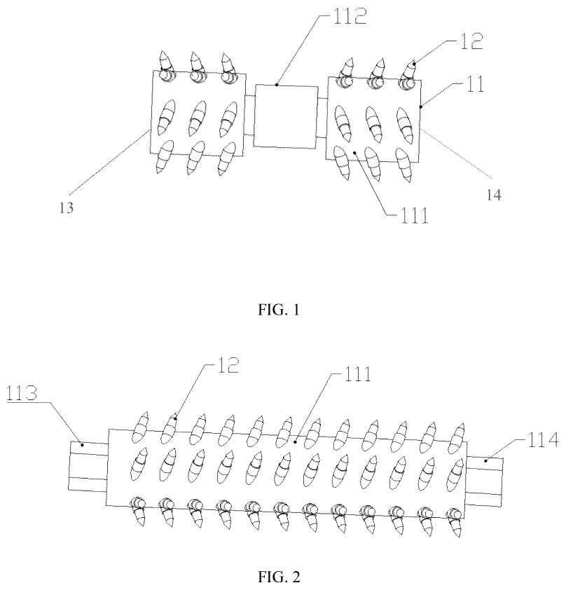

As shown in FIG. 1, a road milling cutter is provided in the first embodiment. The road milling cutter includes a support body 11 in a cylindrical shape, the support body 11 includes a first bottom surface 13, a side surface 111 and a second bottom surface 14 connected sequentially in that order from left to right. Multiple first cutting teeth 12 are fixedly disposed on the side surface 111 and are arranged around a central axis of the support body 11. The support body 11 is configured to rotate around the central axis of the support body 11 to drive the multiple first cutting teeth 12 to cut rocks protruding on a road surface.

As such, for the road milling cutter with the above structure, the support body 11 can rotate around the central axis to drive the multiple first cutting teeth 12 to cut the rocks, resulting in higher rock crushing efficiency. After cutting the rocks, crushed rocks are easily dispersed, and a smoother road surface is formed, which is beneficial to vehicle driving.

In an embodiment, the multiple first cutting teeth 12 are arranged in multiple rows to define rows of first cutting teeth 12, the first cutting teeth 12 in each row of the rows of first cutting teeth 12 extends along the center axis of the supporting body 11 and are spaced at an equal interval, and a spacing between adjacent two rows of the rows of first cutting teeth is equal. In this way, cutting efficiency of the road milling cutter on the rocks is higher.

In an embodiment, the multiple first cutting teeth 12 are inclined towards a rotation direction of the support body 11, and an included angle between each of the multiple first cutting teeth 12 and a tangent plane of the side surface 111 is in a range of 20° to 40°.

In an embodiment, a diameter of the support body 11 is in a range of 30 cm to 100 cm, and a length of the support body 11 is in a range of 100 cm to 400 cm.

Furthermore, in the first embodiment, the length of the support body 11 is in a range of 100 cm to 200 cm, and a first installation portion 112 is provided on a middle part of the support body 11 in a length direction of the support body 11. Therefore, when the length of the support body 11 is relatively shorter, it is only necessary to set an installation portion in the middle part of the support body 11 in the length direction of the support body 11 to connect to a support member, thus achieving stable support of the road milling cutter.

In an embodiment, multiple second cutting teeth are disposed on the first bottom surface 13 and the second bottom surface 14 and are arranged around the central axis of the support body 11. In this way, cutting effect of the road milling cutter on the protruding rocks is further improved. Specifically, in the first embodiment, the multiple second cutting teeth are disposed at edges of the first bottom surface 13 and the second bottom surface 14, and the second cutting teeth are arranged at positions where the first bottom surface 13 and the second bottom surface 14 correspond to the multiple first cutting teeth 12 respectively.

Furthermore, the multiple second cutting teeth are inclined towards the rotation direction of the support body 11, an included angle between each of the multiple second cutting teeth on the first bottom surface 13 and the first bottom surface 13 is in a range of 20° to 40°, and an included angle between each of the multiple second cutting teeth on the second bottom surface 14 and the second bottom surface 14 is in a range of 20° to 40°.

Specifically, a material of cutting teeth (i.e., first cutting teeth 12 and second cutting teeth) is a hard alloy material or a diamond material. The cutting teeth with such material have higher hardness and toughness, resulting in the higher rock crushing efficiency.

### Second Embodiment

The main differences between the second embodiment and the first embodiment are as follows.

As shown in FIG. 2, the length of the support body 11 is in a range of 200 cm to 400 cm. The middle of the support body 11 in the length direction of the support body 11 no longer has the first installation portion 112; instead, two ends of the support body 11 in the length direction of the support body 11 are provided with a second installation portion 113 and a third installation portion 114 respectively. In this way, when the length of the support body 11 is longer, installation portions are set respectively at the two ends of the support body 11 in the length direction of the support body 11 to connect to two support members, which can stably support the road milling cutter.

The second cutting teeth are no longer arranged on the first bottom surface 13 and the second bottom surface 14.

The rest is the same as the first embodiment, and will not be repeated here.

### Third Embodiment

The main differences between the third embodiment and the first embodiment are as follows.

The length of the support body 11 is in a range of 200 cm to 400 cm, and the two ends of the support body 11 in the length direction of the support body 11 are provided with the second installation portion 113 and the third installation portion 114 respectively. In this way, when the length of the support body 11 is longer, the first installation portion 112 is disposed in the middle part of the support body 11 in the length direction of the support body 11, and the second installation portion 113 and the third installation portion 114 are disposed at the two ends of the support body 11 respectively in the length direction of the support body 11 to connect to three support members, which can stably support the road milling cutter.

The second cutting teeth are no longer arranged on the first bottom surface 13 and the second bottom surface 14.

The rest is the same as the first embodiment, and will not be repeated here.

### Fourth Embodiment

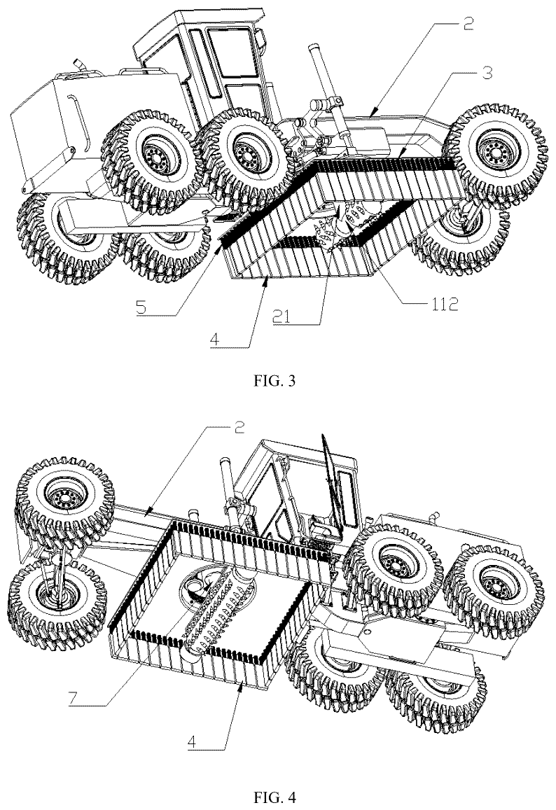

Based on the first embodiment, in the fourth embodiment, a road planing machine is provided. As shown in FIG. 3 and FIG. 8, the road planing machine includes a vehicle body 2 and the road milling cutter as described in the first embodiment. The vehicle body 2 is provided with a first support member 21, which is rotatably connected to the first installation portion 112. A transmission mechanism 9 is installed in the first support member 21, a power input end 91 of the transmission mechanism 9 is mechanically coupled to a power source 10 installed on the vehicle body 2, and a power output end 92 of the transmission mechanism 9 is mechanically coupled to the first installation portion 112. In this way, the road milling cutter can be supported stably through the first support member 21, and the road milling cutter can be driven by the transmission mechanism 9.

In an embodiment, an installation board 3 is disposed on a bottom of the vehicle body 2, a bottom surface of the installation board 3 is connected to multiple cover boards 4 arranged around the road milling cutter, and the multiple cover boards 4 are arranged close to each other. During a process of the road milling cutter cutting the road surface, the multiple cover boards 4 remain in contact with the road surface at all times. With this arrangement, the crushed rocks splashed out when the road milling cutter is configured to rotate to cut the rocks can be contained within the multiple cover boards 4, thereby preventing the crushed rocks from flying out and causing harm.

In an embodiment, each cover board 4 is connected with the installation board 3 through a spring 5. In this way, when the road milling cutter is moving along with a vehicle, the multiple cover boards 4 can fluctuate up and down under an action of the spring 5 when the multiple cover boards 4 touch an uneven road surface, which will not affect vehicle driving, and ensure that each cover board 4 is always in contact with the road surface.

In an embodiment, each cover board 4 is made of a flexible material. In this way, when the road milling cutter is moving along with the vehicle, the multiple flexible cover boards 4 can bend and deform when they come into contact with the uneven road surface, ensuring that multiple cover boards 4 maintain contact with the road surface and block cutting the crushed rocks without affecting the vehicle driving. Moreover, the flexible material of each cover board 4 can better absorb energy of the crushed rocks when the crushed rocks hit each cover board 4. Furthermore, each cover board 4 is made of a rubber material. In this way, the crushed rocks striking each cover board 4 will not make much noise, resulting in lower noise pollution.

In an embodiment, a width of each cover board 4 is in a range of 20 cm to 50 cm, a height of each cover board 4 is in a range of 50 cm to 100 cm, and a thickness of each cover board 4 is in a range of 2 cm to 5 cm.

### Fifth Embodiment

Based on the second embodiment, in the fifth embodiment, the road planing machine is provided. As shown in FIG. 6 and FIG. 9, the road planing machine includes a vehicle body 2 and the road milling cutter as described in the second embodiment. The vehicle body is provided with a second support member 22 and a third support member 23, the second support member 22 is rotatably connected to the second installation portion 113, and the third support member 23 is rotatably connected to the third mounting portion 114. A transmission mechanism 9 is installed in the second support member, a power input end 91 of the transmission mechanism 9 is mechanically coupled to the power source 10 installed on the vehicle body 2, and a power output end 92 of the transmission mechanism 9 is mechanically coupled to the second installation portion 113. In this way, the stable support of the road milling cutter is achieved through the second support member 22 and the third support member 23, and the road milling cutter is driven by the transmission mechanism 9.

### Sixth Embodiment

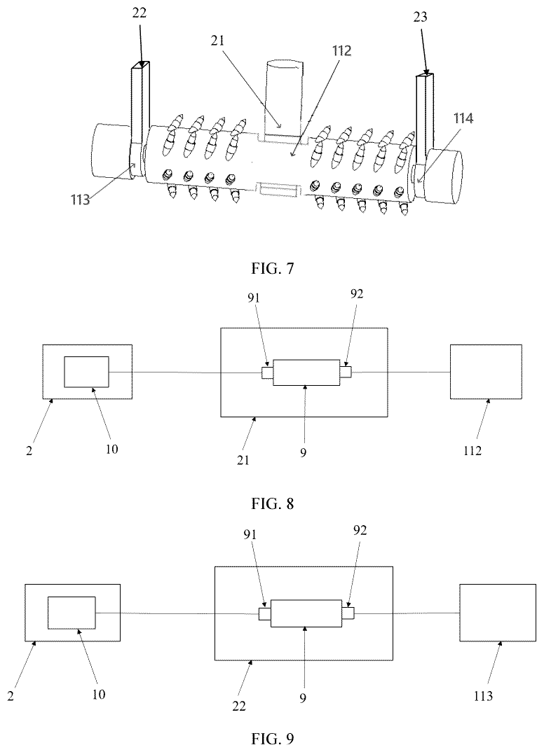

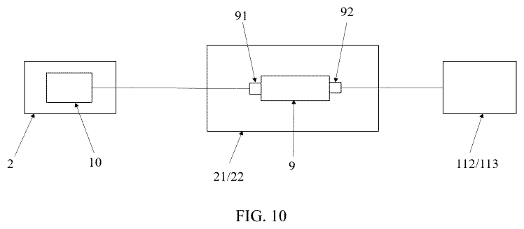

Based on the third embodiment, in the sixth embodiment, the road planing machine is provided. As shown in FIG. 7 and FIG. 10, the road planing machine includes a vehicle body 2 and the road milling cutter as described in the third embodiment. The vehicle body is provided with a first support member 21, a second support member 22 and a third support member 23, the first support member 21 is rotatably connected to the first installation portion 112, the second support member 22 is rotatably connected to the second installation portion 113, and the third support member 23 is rotatably connected to the third installation portion 114. A transmission mechanism 9 is installed in the first support member 21, a power input end 91 of the transmission mechanism 9 is mechanically coupled to the power source 10 installed on the vehicle body 2, and a power output end 92 of the transmission mechanism 9 is mechanically coupled to the first installation portion 112. In this way, the stable support of the road milling cutter is achieved through the first support member 21, the second support member 22, and the third support member 23, and the road milling cutter is driven by the transmission mechanism 9.

### Seventh Embodiment

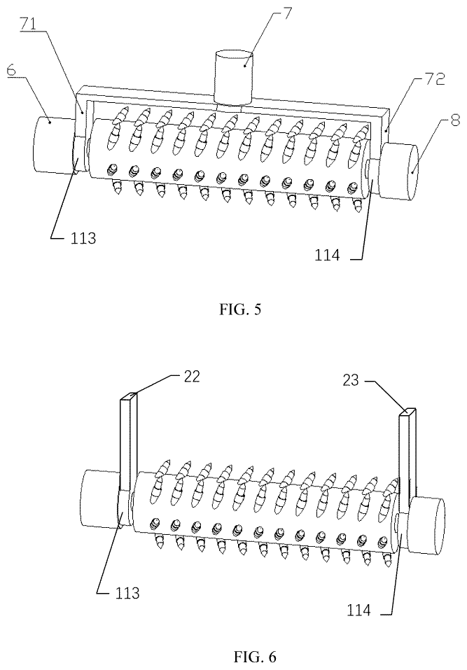

Based on the second embodiment, in the seventh embodiment, the road planing machine is provided. As shown in FIG. 4 and FIG. 5, the road planing machine includes a vehicle body 2, a driving device 6 and the road milling cutter as described in the second embodiment. The vehicle body 2 is provided with a support member 7, and a lower part of the support member 7 is provided with a first support part 71 and a second support part 72 arranged at an interval. The road milling cutter is disposed between the first support part 71 and the second support part 72, the second installation portion 113 is rotatably connected to the first support part 71, and the third installation portion 114 is rotatably connected to the second support part 72. The driving device 6 is installed on the first support part 71 and located on a side of the first support part 71 facing away from the road milling cutter, and the driving device 6 is mechanically coupled to the road milling cutter. Thus, the stable support of the road milling cutter is achieved through the support member 7, and the road milling cutter is driven by the transmission mechanism.

In an embodiment, the road planing machine further includes a counterweight device 8, which is installed on the second support part 72 and located on a side of the second support part 72 facing away from the road milling cutter. In this way, a weight of the driving device 6 is balanced by the counterweight device 8, so that the support of the road milling cutter is more stable.

### Eighth Embodiment

In the eighth embodiment, the road milling method is provided. The road milling method is implemented by the road milling cutter described in any one of the first to the third embodiments to cut the protruding rocks on the road surface, and includes the following steps.

S1, according to an image of a working area of the road surface, the rocks in the working area are identified to obtain a position distribution of the rocks in the working area.

The step S1 includes: the image of the working area is input into a rock detection model, to identify the rocks in the working area and determine positions of the rocks in the working area, and obtain the position distribution of the rocks in the working area.

In an embodiment, the rock detection model is a faster region-based convolutional neural network (Faster R-CNN) model with adaptive weight parameters obtained through a pre-training process.

S2, according to the position distribution of the rocks in the working area and a rock cutting related area for each of the rocks, individual rocks to be cut and rock clusters to be cut are determined, and the rock cutting related area for each of the rock is preset. There is no rock in the rock cutting related area of each of the individual rocks to be cut, there is at least one rock in the rock cutting related area of each rock in the rock clusters to be cut, and the at least one rock belongs to the rock clusters to be cut.

The rock cutting related area is defined as a rock cutting impact area minus a rock cutting area; and the rock cutting area is a region where a circumcircle of a rock is located, and the rock cutting impact area is circular and has a same center with the rock cutting area. A radius of the rock cutting impact area is equal to a radius of the rock cutting area plus n times a diameter of the road milling cutter, where n is in a range of 1 to 1.5.

S3, according to an image of each of the individual rocks to be cut, lithology data of each of the individual rocks to be cut is identified, the lithology data of each of the individual rocks to be cut is input into a cutting parameter generation model to obtain cutting parameters of each of the individual rocks, and each of the individual rocks to be cut is cut by the road milling cutter according to the cutting parameters of each of the individual rocks. During a cutting process of each of the individual rocks to be cut, the cutting parameter of each of the individual rocks are optimized and adjusted, according to a torque, a vibration frequency and a temperature of the road milling cutter.

According to the image of each of the individual rocks to be cut, the lithology data of each of the individual rocks to be cut is identified, which includes: the image of each of the individual rocks to be cut is input into a rock lithology recognition model, to identify the lithology data of each of the individual rocks to be cut. The rock lithology recognition model is a convolutional neural network (CNN) model with adaptive weight parameters obtained through the pre-training process, and the CNN model has a you-only-look-once version 8 (yolov8) network architecture.

Constructing the yolov8 network architecture includes constructing four core parts: Backbone, Neck, Head, and Detect.

Constructing the Backbone part: the Backbone is based on a Darknet-53 convolutional neural network (DarkNet-53) and achieve a feature extraction function from an input image by integrating cross stage partial network fusion (C2F) and spatial pyramid pooling fast (SPPF) modules.

Constructing the Neck part: the Neck is mainly composed of a C2f module and a convolution-batch normalization-sigmoid (CBS) convolutional layer, using a path aggregation network (PANet) structure, connected after the Backbone to obtain extracted features from the Backbone, and integrate the extracted features into a feature pyramid, which enables the CNN model to represent multi-scale information.

Constructing the Head part: the Head part is a core prediction component of the CNN model, which adopts a Decoupled-Head structure to predict a location of a target (such as coordinates of a bounding box), a confidence of the target, and a classification score of the target on the feature pyramid provided by the Neck, achieving category prediction and bounding box prediction.

Constructing the Detect part: the Detect part is a post-processing component of the CNN model, which transforms an output from the Head using an Anchor-Free detection strategy into an actual detection result. For each input image, it outputs a set of bounding boxes, each accompanied by an object confidence score and a class label.

The lithology data of each of the individual rocks includes a type, a mineral composition and an internal structural characteristic of each of the individual rocks. The cutting parameter generation model is a regression model with the adapted weight parameters obtained through the pre-training process, and the cutting parameters of each of the individual rocks include a cutter rotation speed, a cutting feed rate, a cutting depth, and a cutter pressure.

According to the torque, the vibration frequency and the temperature of the road milling cutter, the cutting parameters of each of the individual rocks are optimized and adjusted, which includes: the torque, the vibration frequency and the temperature of the road milling cutter are input into a cutting parameter prediction model, and the cutting parameter prediction model and a pre-constructed objective function are optimized using a genetic algorithm, thus optimized cutting parameters of each of the individual rocks are obtained. The cutting parameter prediction model is established through multivariate nonlinear regression fitting of the cutting parameters of each of the individual rocks with the torque, the vibration frequency, and the temperature of the road milling cutter, using an orthogonal experiment and a generalized regression neural network algorithm.

The pre-constructed objective function is:

$$F ( x ) = {w}_{1} \times N ( x ) + {w}_{2} \times V ( x ) + {w}_{3} \times T ( x )$$

where F(x) represents a comprehensive evaluation index or a value of an objective function; w₁, w₂ and w₃ represent weight coefficients, N(x) represents a vibration frequency under cutting parameters x, V(x) represents a vibration frequency under the cutting parameters x; T(x) represents a temperature under the cutting parameters x.

S4, according to an image of each of the rock clusters to be cut, lithology data of each rock in each of the rock clusters to be cut is identified. The lithology data of a target rock in each of the rock clusters is input into the cutting parameter generation model to obtain target cutting parameters, and each of the rock clusters to be cut is cut starting from the target rock by the road milling cutter. During a cutting process of each of the rock clusters, the target cutting parameters are optimized and adjusted, according to the lithology data of a current rock being cut of each of the rock clusters, the torque, the vibration frequency, and the temperature of the road milling cutter, and the target rock is a first rock to be cut of each of the rock clusters.

According to the image of each of the rock clusters to be cut, the lithology data of each rock in each of the rock clusters to be cut is identified, which includes: the image of each of the rock clusters is divided to obtain an image of each rock in each of the rock clusters to be cut, the image of each rock in each of the rock clusters to be cut is input into the rock lithology recognition model to identify lithology data of each rock in each of the rock clusters to be cut is identified. The rock lithology recognition model is the same as the rock lithology recognition model in the step S3, and will not be further repeated here. The rock lithology data, the cutting parameter generation model, and the target cutting parameters are the same as the cutting parameter generation model, and the cutting parameters of each of the individual rocks in the step S3, and will not be further repeated here.

According to the lithology data of the current rock being cut of each of the rock clusters, the torque, the vibration frequency, and the temperature of the road milling cutter, the target cutting parameters are optimized and adjusted, which includes: the lithology data of the current rock being cut of each of the rock clusters, the torque, the vibration frequency and the temperature of the road milling cutter are input into a cutting parameter prediction model, and the cutting parameter prediction model and a pre-constructed objective function are optimized using the genetic algorithm, thus optimized target cutting parameters are obtained. The cutting parameter prediction model is established through multivariate nonlinear regression fitting of the target cutting parameters with the lithology data of the rock being cut of each of the rock clusters, the torque, the vibration frequency, and the temperature of the road milling cutter, using the orthogonal experiment and the generalized regression neural network algorithm.

The pre-constructed objective function is:

$$F ( x ) = {w}_{1} \times N ( x ) + {w}_{2} \times V ( x ) + {w}_{3} \times T ( x ) + {w}_{4} \times R$$

where F(x) represents a comprehensive evaluation index or a value of an objective function; w₁, w₂ w₃ and w₄ represent weight coefficients, N(x) represents a vibration frequency under target cutting parameters x, V(x) represents a vibration frequency under the target cutting parameters x, T(x) represents a temperature under the target cutting parameters x, and R represents the lithology data of the current rock being cut of each of the rock clusters.

The road milling method provided in the eighth embodiment enables the road milling cutter to efficiently and stably cut rocks with different sizes, thicknesses, and lithologies, in order to achieve the purpose of efficiently and safely planing hard ground surfaces.

In the description of the disclosure, it should be understood that the terms “first” and “second” are used solely for descriptive purposes and should not be construed as indicating or implying relative importance or implicitly specifying the number of the technical features referred to. Therefore, features designated as “first” and “second” can explicitly or implicitly include one or more of such features. In the description of the disclosure, the term “multiple” means two or more, unless otherwise specifically limited.

In the disclosure, unless otherwise specified and defined, the terms “installation”, “connection”, “link”, “fixation” and other terms should be understood in a broad sense, for example, they can be fixed connection, detachable connection, or integrated; It can be mechanical connection or electrical connection; It can be connected directly or indirectly through intermediate media; It can be the connection between two components or the interaction between two components. For those skilled in the art, the specific meaning of the above terms in the disclosure can be understood according to the specific circumstances.

In the disclosure, unless otherwise specifically defined and limited, when a first feature is described as being “on” or “under” a second feature, it can mean that the first and second features are in direct contact or that they are in indirect contact through an intermediary. Moreover, when the first feature is described as being “above”, “over” or “on” the second feature, it can mean that the first feature is directly above or diagonally above the second feature, or it simply indicates that the first feature is at a higher horizontal level than the second feature. When the first feature is described as being “below”, “underneath” or “under” the second feature, it can mean that the first feature is directly below or diagonally below the second feature, or it simply indicates that the first feature is at a lower horizontal level than the second feature.

In the description of the specification, the terms “an embodiment”, “some embodiments”, “embodiment”, “example”, “specific example” or “some examples” refer to the inclusion of specific features, structures, materials, or characteristics described in conjunction with that embodiment or example in at least one embodiment or example of the disclosure. In the specification, the illustrative descriptions of the aforementioned terms do not necessarily pertain to the same embodiment or example. Moreover, the described specific features, structures, materials, or characteristics can be combined in any appropriate manner in any one or more embodiments or examples. Furthermore, unless contradictory, those skilled in the art may combine and integrate different embodiments or examples and the features of different embodiments or examples as described in the specification.

Although the embodiments of the disclosure have been shown and described above, it will be understood that these embodiments are illustrative and not intended to limit the disclosure. Those skilled in the art may make modifications, alterations, substitutions, and variations to the aforementioned embodiments within the scope of the disclosure.

What is claimed is:

1. A road milling cutter, comprising a support body (11) in a cylindrical shape, wherein the support body (11) comprises a first bottom surface (13), a side surface (111) and a second bottom surface (14) connected sequentially in that order from left to right, a plurality of first cutting teeth (12) are fixedly disposed on the side surface (111) and are arranged around a central axis of the support body (11), and the plurality of first cutting teeth (12) are inclined towards a rotation direction of the support body (11); and the support body (11) is configured to rotate around the central axis of the support body (11) to drive the plurality of first cutting teeth (12) for cutting rocks on a road surface.

2. The road milling cutter as claimed in claim 1, wherein the plurality of first cutting teeth (12) are arranged in a plurality of rows to define rows of first cutting teeth (12), the first cutting teeth (12) in each row of the rows of first cutting teeth (12) extends along the central axis of the support body (11) and are spaced at an equal interval, and a spacing between each adjacent two rows of the rows of first cutting teeth (12) is equal.

3. The road milling cutter as claimed in claim 1, a diameter of the support body (11) is in a range of 30 centimeters (cm) to 100 cm, and a length of the support body (11) is in a range of 100 cm to 400 cm.

4. A road planing machine, comprising a vehicle body (2) and the road milling cutter as claimed in claim 1, wherein the road milling cutter is disposed on the vehicle body (2) and configured to be in contact with the road surface to cut the rocks.

5. The road planing machine as claimed in claim 4, wherein a length of the support body (11) is in a range of 100 cm to 400 cm, and a first installation portion (112) is provided on a middle part of the support body (11) in a length direction of the support body (11); the vehicle body (2) is provided with a first support member (21), and the first support member (21) is rotatably connected to the first installation portion (112); a transmission mechanism (9) is installed in the first support member (21), a power input end (91) of the transmission mechanism (9) is mechanically coupled to a power source (10) installed on the vehicle body (2), and a power output end (92) of the transmission mechanism (9) is mechanically coupled to the first installation portion (112); or,
a length of the support body (11) is in a range of 200 cm to 400 cm, and two ends of the support body (11) in the length direction of the support body (11) are provided with a second installation portion (113) and a third installation portion (114) respectively; the vehicle body (2) is provided with a second support member (22) and a third support member (23), the second support member (22) is rotatably connected to the second installation portion (113), and the third support member (23) is rotatably connected to the third installation portion (114); and a transmission mechanism (9) is installed in the second support member (22), a power input end (91) of the transmission mechanism (9) is mechanically coupled to a power source (10) installed on the vehicle body (2), and a power output end (92) of the transmission mechanism (9) is mechanically coupled to the second installation portion (113); or,
a length of the support body (11) is in a range of 200 cm to 400 cm, a first installation portion (112) is provided on a middle part of the support body (11) in the length direction of the support body (11), and two ends of the support body (11) in the length direction of the support body (11) are provided with a second installation portion (113) and a third installation portion (114) respectively; the vehicle body (2) is provided with a first support member (21), a second support member (22) and a third support member (23), the first support member (21) is rotatably connected to the first installation portion (112), the second support member (22) is rotatably connected to the second installation portion (113), and the third support member (23) is rotatably connected to the third installation portion (114); and a transmission mechanism (9) is installed in the first support member (21) or the second support member (22), a power input end (91) of the transmission mechanism (9) is mechanically coupled to a power source (10) installed on the vehicle body (2), and a power output end (92) of the transmission mechanism (9) is mechanically coupled to the first installation portion (112) or the second installation portion (113).

6. The road planing machine as claimed in claim 4, further comprising a driving device (6), wherein a length of the support body (11) is in a range of 200 cm to 400 cm, and two ends of the support body (11) in a length direction of the support body (11) are provided with a second installation portion (113) and a third installation portion (114) respectively; the vehicle body (2) is provided with a support member (7), and a lower part of the support member (7) is provided with a first support part (71) and a second support part (72) arranged at an interval; and the road milling cutter is disposed between the first support part (71) and the second support part (72), the second installation portion (113) is rotatably connected to the first support part (71), and the third installation portion (114) is rotatably connected to the second support part (72); and the driving device (6) is installed on the first support part (71) and located on a side of the first support part (71) facing away from the road milling cutter, and the driving device (6) is mechanically coupled to the road milling cutter.

7. A road milling method, implemented by the road milling cutter as claimed in claim 1 to cut the rocks protruding on the road surface, wherein the road milling method comprises the following steps:
S1, identifying, according to an image of a working area of the road surface, the rocks in the working area to obtain a position distribution of the rocks in the working area;
S2, determining, according to the position distribution of the rocks in the working area and a rock cutting related area for each of the rocks, individual rocks to be cut and rock clusters to be cut, wherein the rock cutting related area for each of the rocks is preset, there is no rock in the rock cutting related area of each of the individual rocks to be cut, there is at least one rock in the rock cutting related area of each rock in the rock clusters to be cut and the at least one rock belongs to the rock clusters to be cut;
S3, identifying, according to an image of each of the individual rocks to be cut, lithology data of each of the individual rocks to be cut; inputting the lithology data of each of the individual rocks to be cut into a cutting parameter generation model to obtain cutting parameters of each of the individual rocks, and cutting each of the individual rocks to be cut by the road milling cutter according to the cutting parameters of each of the individual rocks; during a cutting process of each of the individual rocks to be cut, optimizing and adjusting the cutting parameters of each of the individual rocks according to a torque, a vibration frequency and a temperature of the road milling cutter; and
S4, identifying, according to an image of each of the rock clusters to be cut, lithology data of each rock in each of the rock clusters to be cut; inputting the lithology data of a target rock in each of the rock clusters into the cutting parameter generation model to obtain target cutting parameters, and cutting each of the rock clusters to be cut starting from the target rock by the road milling cutter according to the target cutting parameters; during a cutting process of each of the rock clusters, optimizing and adjusting the target cutting parameters, according to the lithology data of a current rock being cut of each of the rock clusters, the torque, the vibration frequency, and the temperature of the road milling cutter, wherein the target rock is a first rock to be cut of each of the rock clusters.

8. The road milling method as claimed in claim 7, wherein the identifying, according to an image of a working area, the rocks in the working area to obtain a position distribution of the rocks in the working area, comprises:
inputting the image of the working area into a rock detection model, to identify the rocks in the working area and determine positions of the rocks in the working area, and obtain the position distribution of the rocks in the working area, wherein the rock detection model is a faster region-based convolutional neural network (Faster R-CNN) model with adaptive weight parameters obtained through a pre-training process.

9. The road milling method as claimed in claim 7, wherein the rock cutting related area is defined as a rock cutting impact area minus a rock cutting area; and
wherein the rock cutting area is a region where a circumcircle of a rock is located, the rock cutting impact area is circular and has a same center with the rock cutting area, and a radius of the rock cutting impact area is equal to a radius of the rock cutting area plus n times a diameter of the road milling cutter, and n is in a range of 1 to 1.5.

10. The road milling method as claimed in claim 7, wherein the identifying, according to an image of each of the individual rocks to be cut, lithology data of each of the individual rocks to be cut, comprises: inputting the image of each of the individual rocks to be cut into a rock lithology recognition model to identify the lithology data of each of the individual rocks to be cut;
wherein the identifying, according to an image of each of the rock clusters to be cut, lithology data of each rock in each of the rock clusters to be cut, comprises: dividing the image of each of the rock clusters to be cut to obtain an image of each rock in each of the rock clusters to be cut, inputting the image of each rock in each of the rock clusters to be cut into the rock lithology recognition model to identify lithology data of each rock in each of the rock clusters to be cut; and
wherein the rock lithology recognition model is a convolutional neural network (CNN) model with adaptive weight parameters obtained through the pre-training process, and the CNN model has a you-only-look-once version 8 (yolov8) network architecture.
